(19) United States
(12) Patent Application Publication
(10) Pub. No.: US 2026/0230141 A1
(43) Pub. Date: Aug. 6, 2026

(54) CSI DWELLING TIME BASED CSI PREDICTION

(71) Applicant: Google LLC, Mountain View, CA (US)

(72) Inventor: Yushu ZHANG, Beijing (CN)

(21) Appl. No.: 19/152,202

(22) PCT Filed: Feb. 17, 2023
(86) PCT No.: PCT/CN2023/076927

§ 371 Date: Jul. 30, 2025

(51) Int. Cl. H04B 7/06; H04L 41/16; H04W 8/22

(52) U.S. Cl. CPC H04B 7/0626; H04B 7/0632; H04L 41/16; H04W 8/22

(57) ABSTRACT

This disclosure provides systems, devices, apparatus, and methods, including computer programs encoded on storage media, associated with calculating a CSI dwelling time. A UE (102) calculates (510) a channel state information (CSI) dwelling time based on a measurement of a channel state information reference signal (CSI-RS) on at least one CSI-RS resource. Based on the CSI dwelling time, the UE (102) sends (512), to a network entity, at least one report.

### TECHNICAL FIELD

The present disclosure relates generally to wireless communication, and more particularly, to channel state information (CSI) prediction.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a network entity, such as a base station or a unit of a base station, uses CSI reporting to select a digital precoder for a user equipment (UE). However, the CSI may become inaccurate shortly after the network entity receives the CSI report and before a next CSI reporting slot.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity, such as a base station or a unit of a base station, uses CSI reporting to select a digital precoder for a user equipment UE. Precoding supports multiple-input multiple-output (MIMO) communications. The network entity may configure a CSI report by radio resource control (RRC) signaling. To measure wireless channel characteristics, the UE receives a channel state information reference signal (CSI-RS) on a channel measurement resource (CMR). The network entity may also configure an interference measurement resource (IMR) for the UE to measure interference. Using the configured CMR and IMR, the UE measures the CSI-RS and interference. Then, the UE sends a corresponding CSI report to the network entity.

Conventionally, the UE takes channel measurements during a CMR/IMR time duration and later transmits the CSI report based on those measurements performed in the past. However, the CSI may become inaccurate shortly after the network entity receives the CSI report and before a next CSI reporting slot. If this occurs, the network entity may select a precoder or other downlink parameters based on inaccurate information for the current channel conditions. Further, the network entity is unable to determine whether a previously reported CSI is outdated (or not) for the purposes of triggering an aperiodic CSI report at a certain time or configuring a periodic or semi-persistent CSI report with a certain periodicity.

Aspects of the present disclosure address the above-noted and other deficiencies by calculating a CSI dwelling time. For example, the CSI dwelling time might represent a predicted validity duration or predicted effective duration for a CSI, e.g., one or more parameters in the CSI report. The CSI dwelling time might also represent a predicted validity duration or predicted effective duration for a CSI report (as a whole). In some examples, the network entity transmits a first control signaling configuring at least one of: a CSI report based on at least one CSI-RS resource; or a CSI dwelling time report associated with at least one CSI-RS resource. Then, the network entity transmits at least one CSI-RS on the at least one CSI-RS resource for the CSI report or the CSI dwelling time report. The UE measures the CSI-RS and calculates the CSI dwelling time for the CSI report. The CSI dwelling time assists the network entity in determining a periodicity for periodic or semi-persistent CSI reports or triggering an aperiodic CSI report. As an example, the UE indicates the CSI dwelling time and the CSI parameters in a single report transmitted to the network entity. As another example, the UE indicates the CSI dwelling time and the CSI parameters in separate reports transmitted to the network entity. After receiving the report(s) including the indication of the CSI dwelling time, the network entity might transmit a third control signaling updating the periodicity for the periodic or semi-persistent CSI-RS or CSI report. The third control signaling might include a DCI or MAC CE signaling. As still another example, the UE does not report the CSI dwelling time. However, the UE determines whether to transmit the CSI report based on the calculated CSI dwelling time.

According to some aspects, a UE calculates an CSI dwelling time based on a measurement of a CSI-RS on at least one CSI-RS resource. Based on the CSI dwelling time, the UE sends, to a network entity, at least one report.

According to some aspects, a network entity configures at least one report associated with an CSI-RS transmitted on at least one CSI-RS resource. The network entity receives, from a UE, the at least one report associated with the CSI-RS based on a CSI dwelling time.

Advantageously, based on the CSI dwelling time, the network determines a periodicity for periodic or semi-persistent CSI reports or a time for triggering an aperiodic CSI report. In this manner, the UE reduces the possibility of sending unnecessary CSI reports, which saves network resources. In the meantime, the network entity selects a precoder or other downlink parameters based on accurate information for the current channel conditions, thereby improving system performance.

### BRIEF DESCRIPTION OF THE DRAWINGS

FIG. 1 illustrates a diagram of a wireless communications system that includes a plurality of user equipments (UEs) and network entities in communication over one or more cells.

FIG. 2 is a signaling diagram illustrating an example of communications between a user equipment (UE) and a network entity associated with a CSI dwelling time.

FIG. 3 is a signaling diagram illustrating another example of communications between a user equipment (UE) and a network entity associated with a CSI dwelling time with the UE determining whether to send a CSI report.

FIG. 4 is a signaling diagram illustrating still another example of communications between a user equipment (UE) and a network entity associated with a CSI dwelling time with the UE determining whether a CSI report includes an indicator for CSI dwelling time.

FIG. 5 is a flowchart of a method of wireless communication at a UE associated with a CSI dwelling time.

FIG. 6 is a flowchart of a method of wireless communication at a network entity associated with a CSI dwelling time.

FIG. 7A is a diagram illustrating an example of calculating a CSI dwelling time.

FIG. 7B is a flowchart of a method of calculating a CSI dwelling time.

FIG. 8 is a diagram illustrating an example of a CSI dwelling time report for a subset of configured CSI-RS resource(s).

FIG. 9 is a diagram illustrating an example of a CSI dwelling time report for all configured CSI-RS resource(s).

FIG. 10 is a diagram illustrating an example of the CSI and CSI dwelling time reported.

FIG. 11 is a diagram illustrating an example of the CSI dwelling time reported CSI part 1 in long PUCCH or PUSCH.

FIG. 12 is a diagram illustrating an example of the CSI dwelling time reported CSI part 2 in long PUCCH or PUSCH.

FIG. 13 is a diagram illustrating an example of the UE-determined CSI report.

FIG. 14 is a diagram illustrating an example of UE-triggered CSI report

FIG. 15 is a diagram illustrating an example of the CSI report with a CSI parameter presence status.

FIG. 16 is a diagram illustrating an example of the CSI report with an implicit indication of the report status for each CSI parameter.

FIG. 17 is a diagram illustrating an example of the CSI report with a number of CSI reports in CSI part 0.

FIG. 18 is a flowchart of a method of wireless communication at a UE for CSI predicting based on a CSI dwelling time.

FIG. 19 is a flowchart of a method of wireless communication at a network entity for CSI predicting based on a CSI dwelling time.

FIG. 20 is a diagram illustrating a hardware implementation for an example UE apparatus.

FIG. 21 is a diagram illustrating a hardware implementation for one or more example network entities.

### DETAILED DESCRIPTION

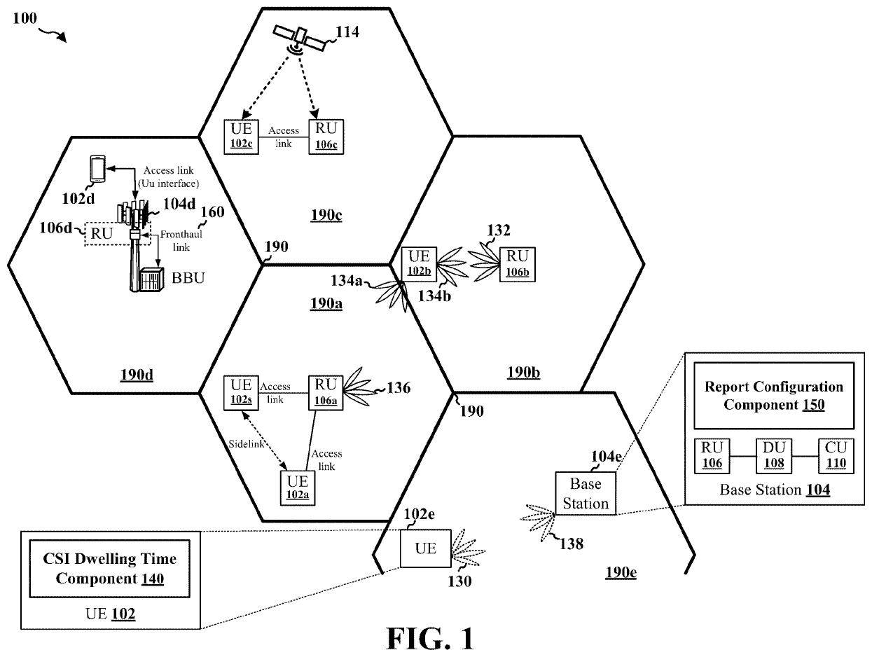

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108, may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104a/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Associated DUs 108 control both real-time and non-real-time features of control plane and user plane communications of the RUs 106

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas 114 of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a CSI dwelling time component 140 configured to calculate a channel state information (CSI) dwelling time based on a measurement of a channel state information reference signal (CSI-RS) on at least one CSI-RS resource. The CSI dwelling time component 140 is configured to: based on the CSI dwelling time, sending, to a network entity, at least one report.

In certain aspects, any of the base stations 104 or a network entity of the base stations 104 may include a report configuration component 150 configured to configure at least one report associated with a channel state information reference signal (CSI-RS) transmitted on at least one CSI-RS resource. The report configuration component 150 is further configured to receive, from a user equipment (UE), the at least one report associated with the CSI-RS based on a CSI dwelling time.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

As mentioned previously, the reported CSI may become inaccurate shortly after the network entity receives the CSI report and before a next CSI reporting slot. For example, if an interval between two CSI reports is too large, the network entity transmits the downlink signal based on outdated CSI for at least a portion of the interval, which may result in a performance loss of the wireless communication system. In another example, if the interval for the two CSI reports is too small, the UE sends unnecessary (e.g., too many/too frequent) CSI reports. In a “too small” situation, the UE does not have to send the second CSI report because the first CSI report is still valid. Such unnecessary CSI reporting increases the system overhead, which may cause performance degradation in the wireless communication system.

To address these CSI under-reporting and over-reporting issues, the UE 102 calculates a CSI dwelling time. For example, the CSI dwelling time might represent a predicted validity duration or predicted effective duration for a CSI, e.g., one or more parameters in the CSI report. The CSI dwelling time might also represent a predicted validity duration or predicted effective duration for a CSI report (as a whole). In one example, the UE can perform a machine learning inference based on the previously measured CSIs. Then the UE can predict the dwelling time for a CSI report. Such CSI dwelling time can assist the network entity to determine a better periodicity for periodic or semi-persistent CSI report or trigger the aperiodic CSI report at a proper time.

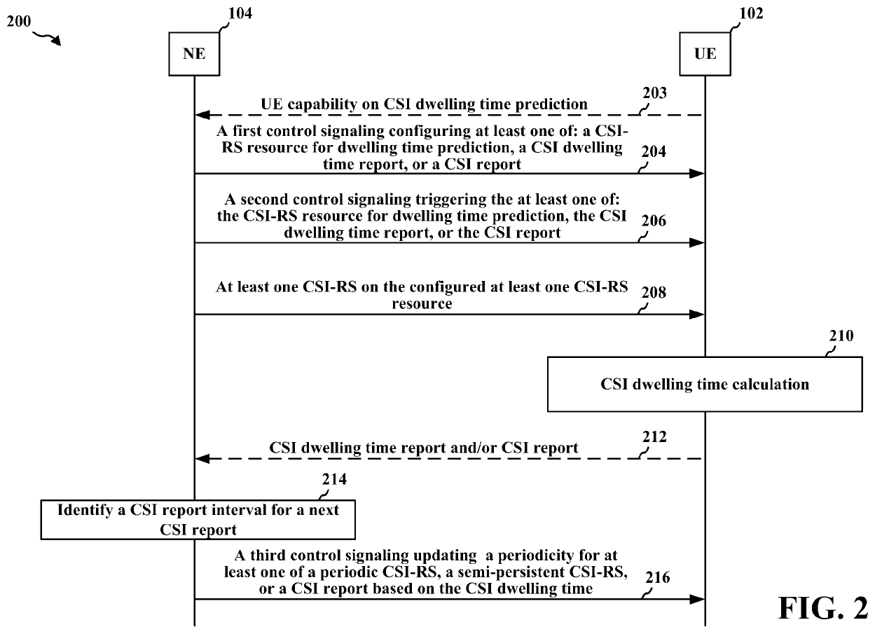

FIG. 2 is a signaling diagram 200 illustrating an example of communications between the UE 102 and the network entity 104 associated with the CSI dwelling time. The network entity 104 may correspond to a base station or a unit of a base station, such as the RU 106, the DU 108, the CU 110, etc. Referring to FIG. 2, the UE 104 may report 203 the UE capabilities at least indicating whether it supports CSI dwelling time prediction. For another example, the network entity may receive the UE capability from a core network (e.g., Access and Mobility Management Function (AMF)) or another network entity.

In some examples, the UE may transmit 203 the UE capability on the CSI dwelling time calculation indicating at least one of the elements: whether the UE supports the CSI dwelling time calculation; the minimum number of measured CSI-RS instances needed for the CSI dwelling time calculation; the supported interval(s) between two consecutive CSI-RS instances for the CSI dwelling time calculation.

Based on the received UE capabilities, the network entity 104 may transmit 204 a first control signaling configuring at least one of: a CSI-RS resource for dwelling time prediction, a CSI dwelling time report, or a CSI report. For example, the network entity 104 may transmit 204 the first control signaling configuring at least one CSI report configuration for CSI report and CSI dwelling time report based on at least one CSI-RS resource. The network entity may transmit the first control signaling by RRC signaling, e.g., RRCReconfiguration or CSI-ReportConfig, or a System Information Block (SIB), where the SIB can be an existing SIB (e.g., SIB1) or a new SIB (e.g., SIB J, where J is an integer above 21) transmitted by the network entity.

In some examples, for semi-persistent CSI-RS and/or CSI report or aperiodic CSI-RS and/or CSI report, the network entity 104 may transmit 206 a second control signaling, e.g., MAC CE or DCI, triggering at least one of: the CSI-RS resource for dwelling time prediction, the CSI dwelling time report, or the CSI report. Then the network entity 104 transmits 208 the CSI-RS on at least one CSI-RS resource.

The UE 102 performs 210 CSI measurement and/or CSI dwelling time calculation based on the received CSI-RS. The UE 102 may send 212 the CSI dwelling time report and/or CSI report to the network entity 104. In some examples, the CSI report and CSI dwelling time report are based on common CSI-RS resource(s). In some other examples, the CSI report and CSI dwelling time report are based on separate CSI-RS resource(s). In some examples, the UE may transmit 212 the CSI dwelling time and CSI in a single report. In some other examples, the UE may transmit 212 the CSI dwelling time and CSI in separate reports.

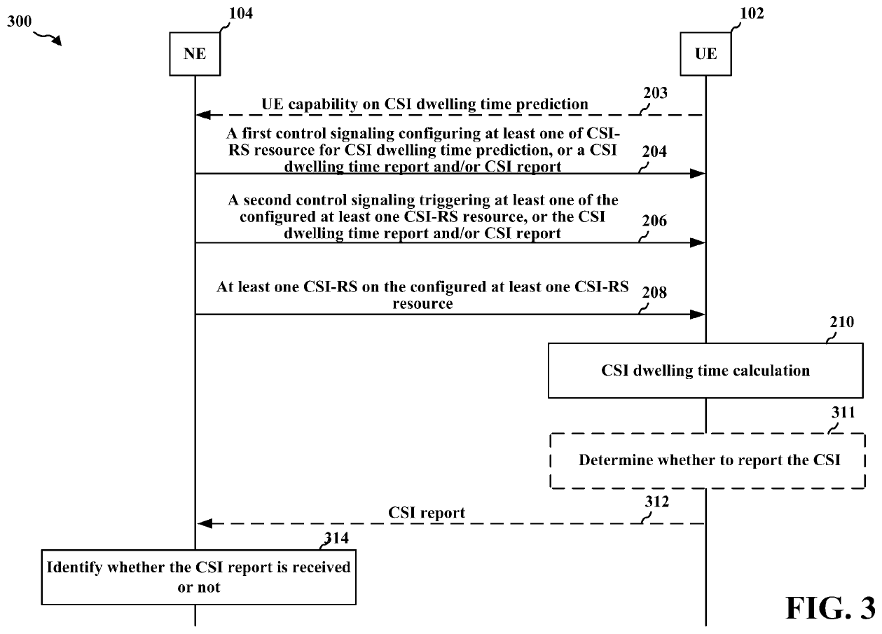

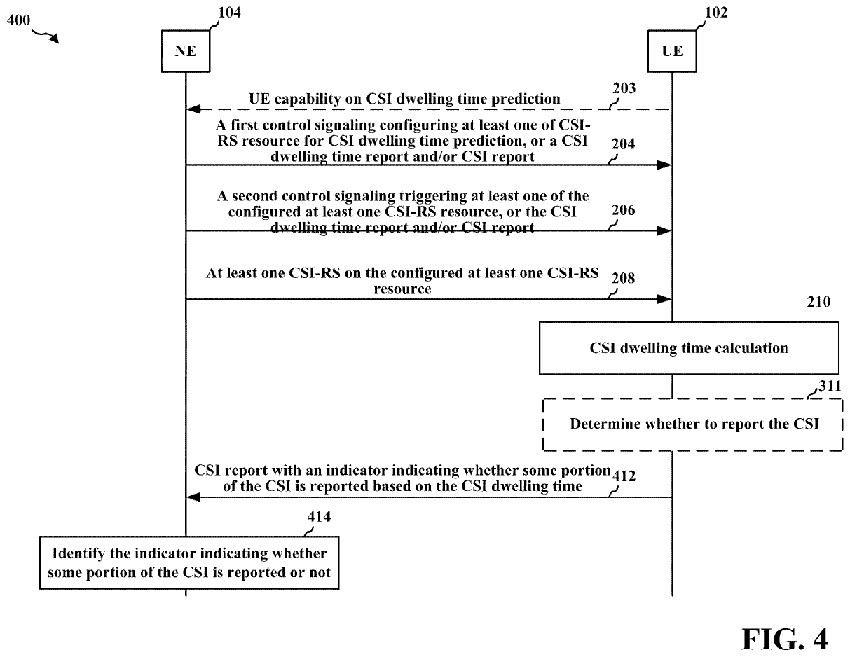

After receiving the CSI dwelling time, the network entity may identify 214 a CSI report interval for a next CSI report. The network entity may transmit 216 a third control signaling updating the periodicity for receiving the periodic or semi-persistent CSI-RS or transmitting a future CSI report. For example, the third control signaling includes a DCI or MAC CE signaling. Other examples of communications between the UE 102 and the network entity 104 associated with the CSI dwelling time will be discussed below in connection with FIG. 3 and FIG. 4.

FIG. 3 is a signaling diagram 300 illustrating another example of communications between the UE 102 and the network entity 104 associated with the CSI dwelling time. Compared to the procedure in FIG. 2, the difference is that in FIG. 3, after the UE 102 performs 210 a CSI measurement and/or CSI dwelling time calculation, the UE 102 does not report the CSI dwelling time, but the UE 102 may determine 311 whether to report the CSI, e.g., send a CSI report, based on the calculated CSI dwelling time. If the network entity 104 triggers or configures the CSI report with a smaller time offset from the most-recent CSI report than the CSI dwelling time, the UE 102 can determine to not transmit the CSI report; otherwise, the UE can transmit 312 the CSI report at the scheduled time. For example, if the time duration from the most-recent CSI report slot to the subsequent CSI report slot is smaller than the CSI dwelling time, the most-recent CSI report is still valid. Thus, the UE 102 determines not to transmit the CSI report, in order to reduce overhead. On the other hand, if the network entity 104 does not trigger the CSI report after the CSI dwelling time, the UE 102 may trigger the CSI report, since the most-recent CSI report is not valid after the CSI dwelling time elapses. The network entity 104 may identify 314 whether the CSI report is received or not. Another example of communications between the UE 102 and the network entity 104 associated with the CSI dwelling time will be discussed below in connection with FIG. 4.

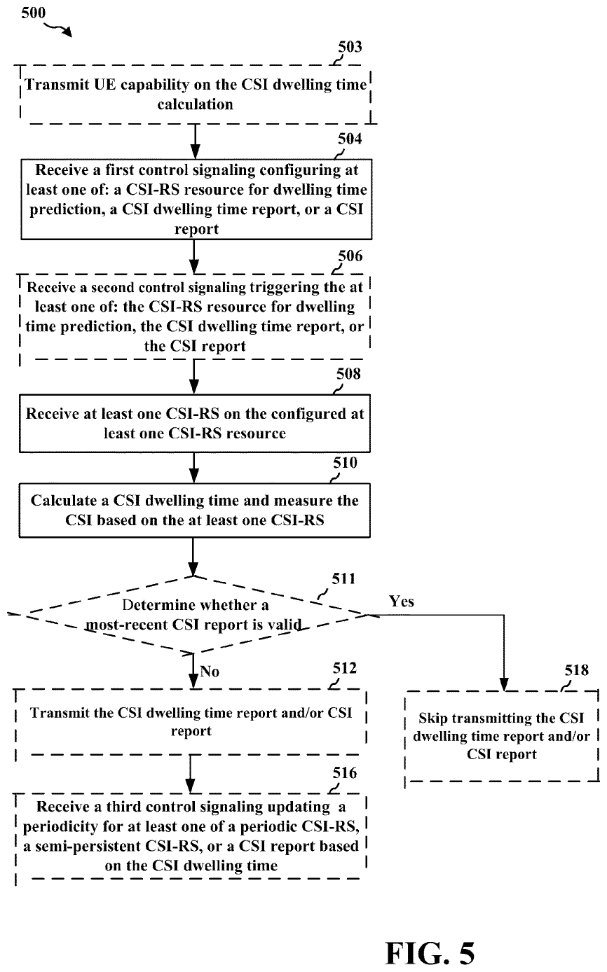

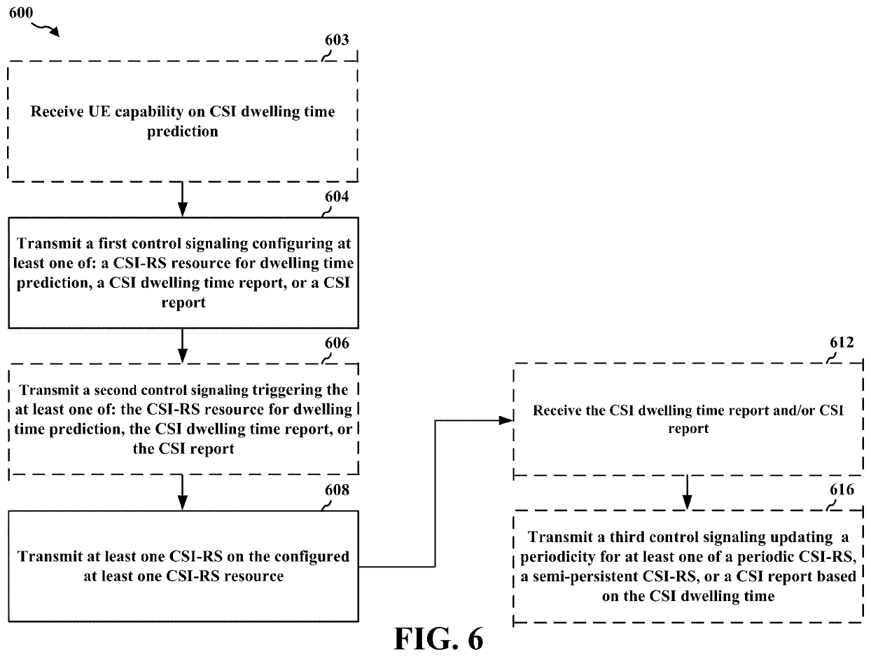

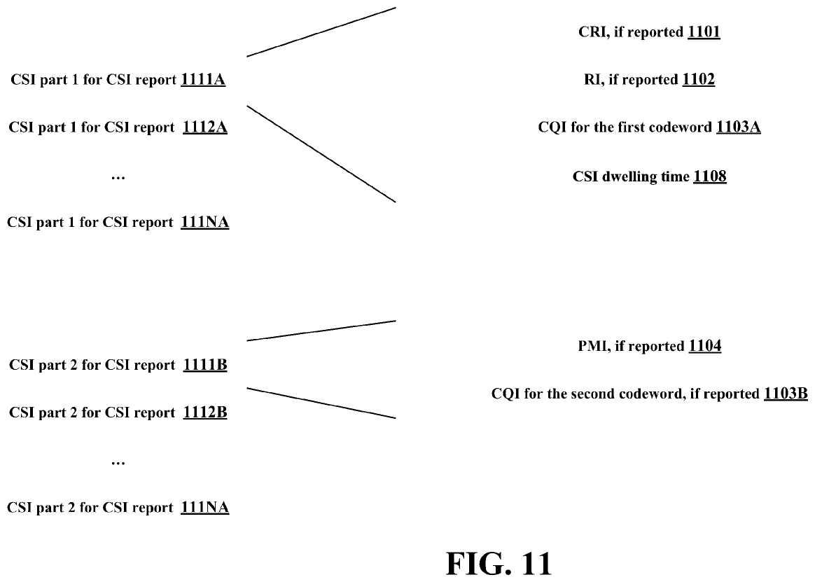

FIG. 4 is a signaling diagram 400 illustrating still another example of communications between the UE 102 and the network entity 104 associated with the CSI dwelling time. Compared to the procedure in FIG. 3, the difference is that in FIG. 4, the UE 102 transmits 412 the triggered or configured CSI report with an indicator indicating whether some portions of the CSI, e.g., PMI, are reported or not. The CSI may include at least one of rank indicator (RI), precoder matrix indicator (PMI), channel quality indicator (CQI) and layer indicator (LI). RI and PMI are used to indicate the digital precoder, CQI is used to indicate the signal-to-interference plus noise (SINR) status so as to assist the network entity to determine the modulation and coding scheme (MCS), and LI is used to identify the strongest layer for the reported precoder indicated by RI and PMI. Based on the calculated CSI dwelling time, the UE 102 may determine whether to report some portions of the CSI, e.g., PMI. The details of the CSI report will be discussed below, e.g., in connection with FIGS. 11, 12, 15 and 16. The network entity 104 may identify 414 the indicator indicating whether some portion of the CSI is reported or not. The UE behavior and the network entity behavior on the CSI dwelling time calculation will be discussed in FIG. 5 and FIG. 6 respectively.

FIGS. 2-4 illustrate examples of communications between the UE 102 and the network entity 104 associated with the CSI dwelling time. FIGS. 5-6 show methods for implementing one or more aspects of FIGS. 2-4. In particular, FIG. 5 shows an implementation by the UE 102 of the one or more aspects of FIGS. 2-4. FIG. 6 shows an implementation by the network entity 104 of the one or more aspects of FIGS. 2-4.

FIG. 5 is a flowchart 500 of a method of wireless communication at the UE 102 associated with the CSI dwelling time calculation. Referring to FIG. 5, the UE 102 may transmit 503 UE capability on the CSI dwelling time calculation. The UE 102 receives 504 a first control signaling configuring at least one of: a CSI-RS resource for dwelling time prediction, a CSI dwelling time report, or a CSI report. In one example, the UE 102 receives 506 a second control signaling triggering the at least one of: the CSI-RS resource for dwelling time prediction, the CSI dwelling time report, or the CSI report.

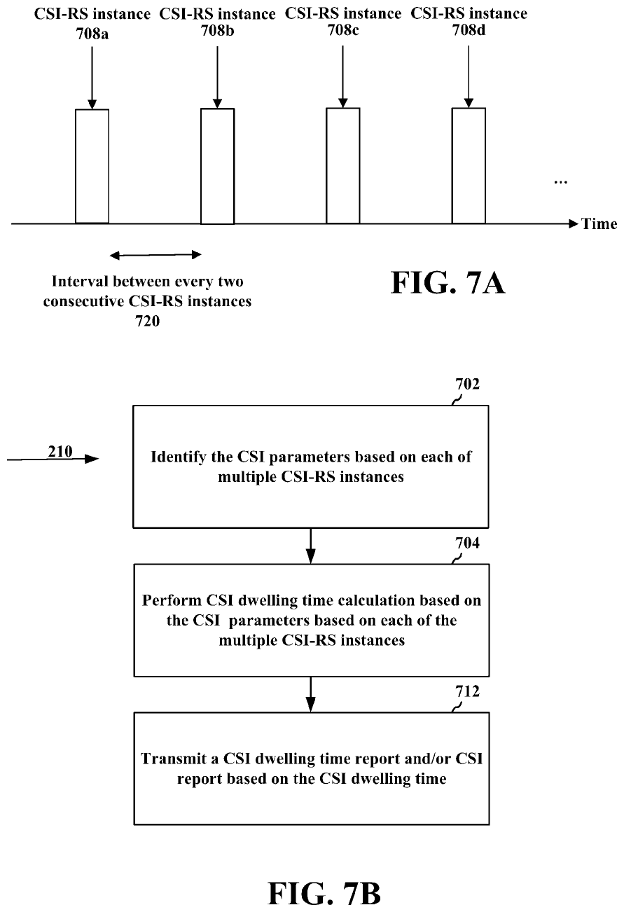

The UE 120 receives 508 at least one CSI-RS on the configured at least one CSI-RS resource. The UE 102 computes 510 the CSI dwelling time and measure the CSI based on the at least one CSI-RS. The details regarding how the UE 102 compute or calculate the CSI dwelling time will be discussed below in connection with FIGS. 7A to 7B.

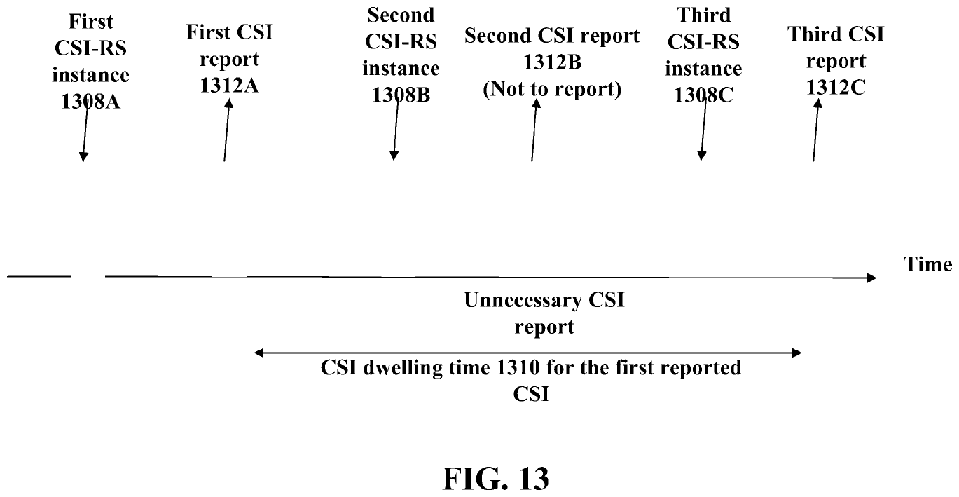

In one example, the UE 102 may determine 511 whether a most-recent CSI report is valid. The details regarding how the UE 102 may determine 511 whether the most-recent CSI report is valid will be discussed below in connection with FIG. 13. When the UE 102 determines that the most-recent CSI report is still valid, the UE 102 may skip 518 transmitting the CSI dwelling time report and/or CSI report, in order to reduce communication overhead and save computing resources.

When the UE 102 determines that the most-recent CSI report is not valid, the UE 102 may transmit 512 the CSI dwelling time report and/or the CSI report. As an example, the UE 102 transmits the CSI dwelling time report. As another example, the UE 102 transmits the CSI report based on the CSI dwelling time. As still another example, the UE 102 transmits a joint CSI and CSI dwelling time report. The details of the CSI dwelling time report and/or the CSI report will be discussed below, e.g., in connection with FIGS. 11, 12, 15 and 16.

The CSI dwelling time assists the network entity in determining a periodicity for periodic or semi-persistent CSI reports or triggering an aperiodic CSI report. After receiving the report(s) including the indication of the CSI dwelling time, the network entity might transmit a third control signaling updating the periodicity for the periodic or semi-persistent CSI-RS or CSI report. For example, the third control signaling includes a DCI or MAC CE signaling. The UE 102 may receive 516 the third control signaling updating a periodicity for at least one of a periodic CSI-RS, a semi-persistent CSI-RS, or a CSI report based on the CSI dwelling time.

FIG. 6 is a flowchart 600 of a method of wireless communication at the network entity 104 associated with the CSI dwelling time calculation. Referring to FIG. 6, the network entity 104 may receive 603 the UE capability on the CSI dwelling time calculation. The network entity 104 transmits 604 a first control signaling configuring at least one of: a CSI-RS resource for dwelling time prediction, a CSI dwelling time report, or a CSI report. In one example, the network entity 104 transmits 606 a second control signaling triggering the at least one of: the CSI-RS resource for dwelling time prediction, the CSI dwelling time report, or the CSI report.

The network entity 104 transmits 608 at least one CSI-RS on the configured at least one CSI-RS resource.

The network entity 104 may receive 612 the CSI dwelling time report and/or the CSI report. As an example, the network entity 104 receives the CSI dwelling time report. As another example, the network entity 104 receives the CSI report. As still another example, the network entity 104 receives a joint CSI and CSI dwelling time report.

The CSI dwelling time assists the network entity in determining a periodicity for periodic or semi-persistent CSI reports or triggering an aperiodic CSI report. After receiving the report(s) including the indication of the CSI dwelling time, the network entity might transmit 616 a third control signaling updating a periodicity for at least one of a periodic CSI-RS, a semi-persistent CSI-RS, or a CSI report based on the CSI dwelling time. For example, the third control signaling includes a DCI or

MAC CE signaling. FIGS. 7A to 7B illustrate the details regarding how the UE 102 compute or calculate the CSI dwelling time.

FIG. 7A is a diagram illustrating an example of computing/calculating the CSI dwelling time. In some examples, the UE 102 performs the CSI dwelling time calculation using machine learning (ML), where the input for the ML could be the measurement results, e.g., CSI, for multiple CSI-RS instances. Different ML architecture could require different types of input, e.g., different number of CSIs and/or different interval between every two consecutive CSI-RS instances. Thus, the UE may report the minimum number of CSI-RS instances for the CSI dwelling time calculation and the supported intervals between every two consecutive CSI-RS instances.

Referring to FIG. 7A, the UE 102 may receive multiple CSI-RS instances 708a, 708b, 708c, and 708d. The UE 102 supports the interval between every two consecutive CSI-RS instances 720. The UE 102 may calculate the CSI dwelling time based on the multiple CSI-RS instances 708a, 708b, 708c, and 708d, which will be discussed below in connection with FIG. 7B.

FIG. 7B is a flowchart of a method of computing/calculating a CSI dwelling time. As discussed above, the UE 102 performs 210 CSI measurement and/or CSI dwelling time calculation based on the received CSI-RS. To perform 210 CSI measurement and/or CSI dwelling time calculation, the UE identifies 702 the CSI parameters based on each CSI-RS instance of the multiple CSI-RS instances 708a, 708b, 708c, and 708d, then the UE performs 704 the CSI dwelling time calculation based on the CSI parameters from each CSI-RS instance of the multiple CSI-RS instances. For example, the UE measures the CSI from each CSI-RS instance. As discussed above, the CSI parameters may include at least one of rank indicator (RI), precoder matrix indicator (PMI), channel quality indicator (CQI) and layer indicator (LI). In one example, the UE uses ML to compute/calculate the CSI dwelling time. Based on the CSI parameters of the multiple CSI-RS instances, the UE may compute/calculate the CSI dwelling time using ML.

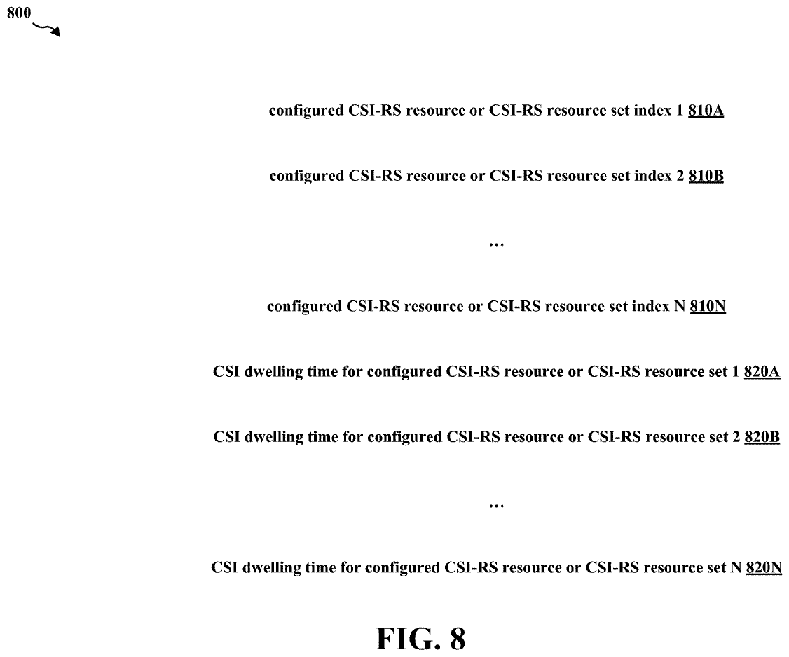

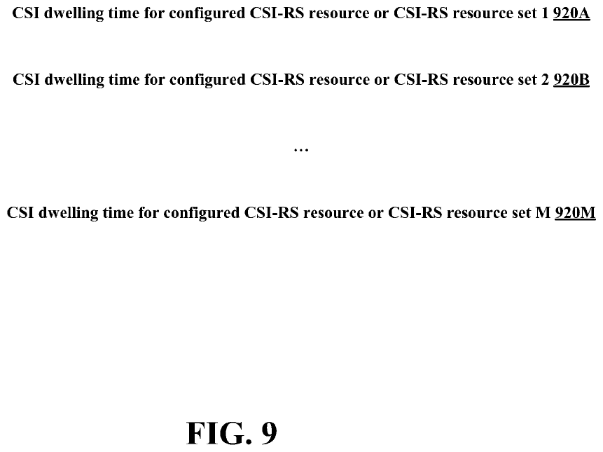

Afterwards, in some examples, the UE transmits 706 a CSI dwelling time report and/or CSI report based on the CSI dwelling time. As an example, the UE transmits the CSI dwelling time report indicating the CSI dwelling time. As another example, the UE transmits the CSI report indicating the CSI dwelling time and the CSI parameters. In some examples, the UE 102 may transmit an independent CSI dwelling time report. FIG. 8 and FIG. 9 illustrate examples of the independent CSI dwelling time report.

FIG. 8 is a diagram 800 illustrating an example of the CSI dwelling time report for a subset of configured CSI-RS resource(s). The network entity 104 may configure a report configuration for the CSI dwelling time report only by the first control signaling and/or the second control signaling. In some examples, the network entity configures an RRC parameter, e.g., enableCsiDwellingTimeReport, enabling the CSI dwelling time report for a CSI report configuration, e.g., CSI-ReporConfig. In some other examples, the network entity may configure the candidate value of the report quantity, e.g., reportQuantity, for a report configuration, e.g., CSI-ReporConfig as the joint CSI and CSI dwelling time report, e.g., csiDwellingTime.

Referring to FIG. 8, the network entity 104 may configure a CSI-RS resource or a set of CSI-RS resources or multiple sets of CSI-RS resources for the CSI dwelling time report. In some examples, the UE may report the CSI-RS resource index and/or CSI-RS resource set index (e.g., 810A, 810B, . . . , 810N) in addition to the CSI dwelling time (e.g., 820A, 820B, . . . , 820N). The CSI dwelling time report may include the configured CSI-RS resource or CSI-RS resource set index 810A, 810B, . . . , 810N and the CSI dwelling time 820A, 820B, . . . , 820N for the configured CSI-RS resource or CSI-RS resource set respectively. For example, there may be a total of M configured CSI-RS resource or CSI-RS resource set. The CSI dwelling time report may include the CSI dwelling time (e.g., 820A, 820B, . . . , 820N) for a subset (e.g., 810A, 810B, . . . , 810N) of all the configured CSI-RS resource or CSI-RS resource set respectively.

FIG. 9 is a diagram 900 illustrating an example of the CSI dwelling time report for all configured CSI-RS resource(s). In some examples, the UE may report the CSI dwelling time (e.g., 920A, 920B, . . . , 920M) for all the configured CSI-RS resource or CSI-RS resource set in the CSI dwelling time report. The CSI dwelling time report may include the CSI dwelling time 920A, 920B, . . . , 920M for each of the configured CSI-RS resource or CSI-RS resource set respectively. For example, there may be a total of M configured CSI-RS resource or CSI-RS resource set. The CSI dwelling time report may include the CSI dwelling time (e.g., 920A, 920B, . . . , 920M) for all the configured CSI-RS resource or CSI-RS resource set respectively.

Referring to FIG. 8 and FIG. 9, in some examples, the UE 102 reports the CSI dwelling time by PUCCH. The network entity 104 configures or indicates at least one PUCCH resource for the CSI dwelling time report by the first and/or the second control signaling. If the network entity 104 configures a PUCCH with long PUCCH format, e.g., PUCCH with more than 4 symbols, the UE 102 may report the CSI dwelling time in CSI part 1 or CSI part 2.

In some other examples, the UE 102 reports the CSI dwelling time as uplink control information multiplexed in PUSCH. The network entity 104 configures or indicates at least one PUSCH resource for the CSI dwelling time report by the first and/or the second control signaling. The UE may report the CSI dwelling time in CSI part 1 or CSI part 2.

In some other examples, the UE 102 reports the CSI dwelling time by MAC CE. The network entity 104 may configure or trigger the PUSCH resource for the MAC CE report by the first or the second control signaling. The UE 102 may transmit the MAC CE including at least one of the elements: serving cell index or serving cell group index, bandwidth part index, report configuration index configured for CSI dwelling time report, CSI-RS resource index or CSI-RS resource set index, and CSI dwelling time.

In some examples, the UE 102 reports the CSI dwelling time in the unit of slot based on a reference subcarrier spacing, where the reference subcarrier spacing may be the subcarrier spacing for the CSI-RS or the subcarrier spacing for the CSI report. In some other examples, the UE 102 reports the CSI dwelling time in the unit of subframe or millisecond. The candidate value of the CSI dwelling time may be predefined, e.g., the same as the candidate periodicity for periodic CSI-RS or periodic CSI report, or configured by the network entity 104 via the first or the second control signaling. In some examples, the UE 102 may transmit a joint CSI and CSI dwelling time report, which may also be referred as a CSI report (e.g., based on the CSI dwelling time).

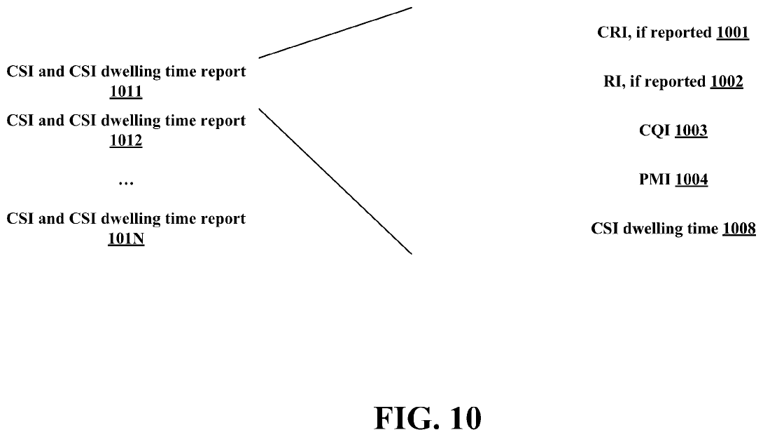

FIGS. 10-12 are diagrams illustrating examples of the CSI report or the joint CSI and CSI dwelling time report. In some examples, the network entity 104 configures a report configuration for the joint CSI and CSI dwelling time report by the first control signaling and/or the second control signaling. Compared to the independent CSI dwelling time report, the difference is that in the CSI report or the joint CSI and

CSI dwelling time report, the UE 102 reports the CSI, e.g., CRI, RI, CQI, PMI and so on, and CSI dwelling time in a single report instance.

Referring to FIG. 10, the UE 102 transmits the CSI report or the CSI and CSI dwelling time reports (e.g., 1011, 1012, . . . , 101N) in short PUCCH, e.g., PUCCH with 4 or less than 4 symbols. For example, the CSI report or the CSI and CSI dwelling time report 1011 includes CRI 1001 (if reported), RI 1002 (if reported), CQI 1003, PMI 1004, and the CSI dwelling time 1008.

Referring to FIG. 11, the UE transmits the CSI report or the CSI and CSI dwelling time reports (e.g., 1111, 1112, . . . , 111N) in long PUCCH, e.g., PUCCH with more than 4 symbols, or PUSCH in CSI part 1. For example, CSI part 1 for the CSI report 1111A includes CRI 1101 (if reported), RI 1102 (if reported), CQI for the first codeword 1103A, and the CSI dwelling time 1108, while CSI part 2 for the CSI report 1111B includes PMI 1104 (if reported), and CQI for the second codeword 1103B (if reported).

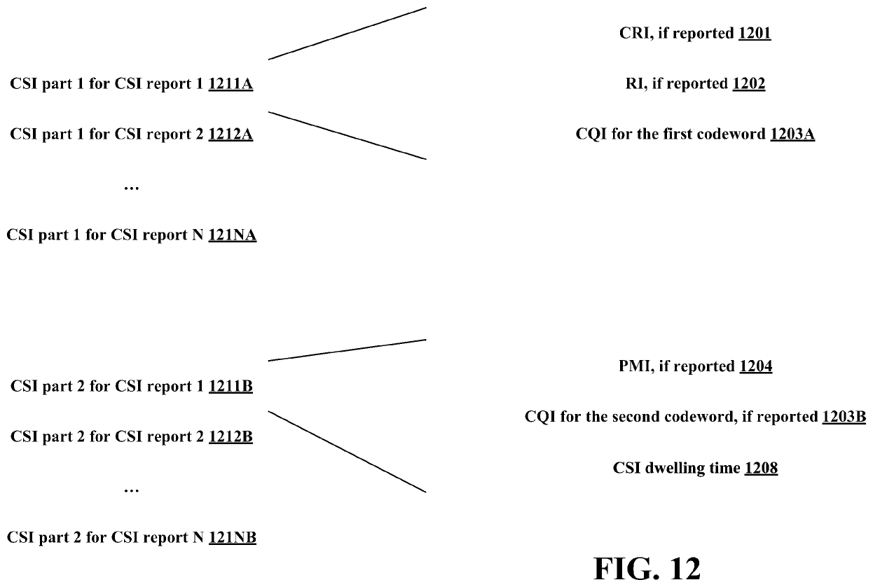

Referring to FIG. 12, the UE transmits CSI report or the CSI and CSI dwelling time reports (e.g., 1211, 1212, . . . , 121N) in long PUCCH, e.g., PUCCH with more than 4 symbols, or PUSCH in CSI part 2. For example, CSI part 1 for the CSI report 1211A includes CRI 1201 (if reported), RI 1202 (if reported), and CQI for the first codeword 1203A, while CSI part 2 for the CSI report 1211B includes PMI 1204 (if reported), CQI for the second codeword 1203B (if reported), and the CSI dwelling time 1208.

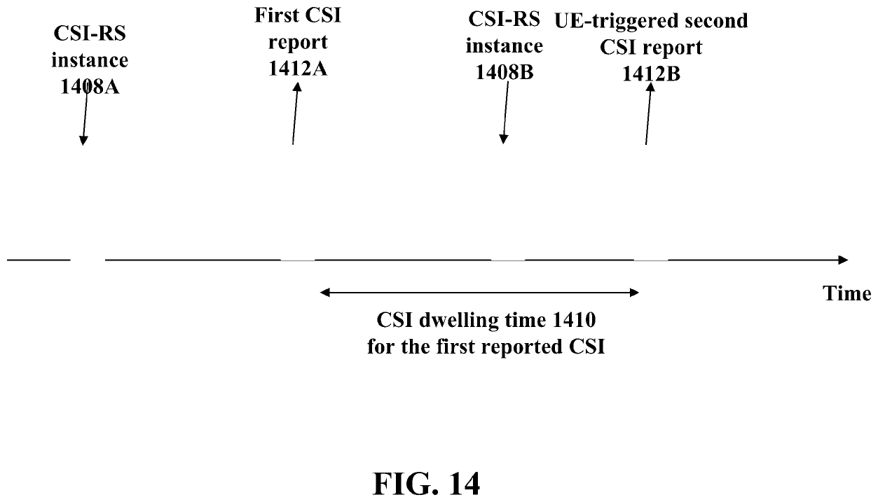

Referring to FIGS. 10-12, the network entity configures an RRC parameter, e.g., enableCsiDwellingTimeReport, enabling the CSI dwelling time report for a CSI report configuration, e.g., CSI-ReporConfig. In some other implementations, the network entity configures the candidate value of the report quantity, e.g., reportQuantity, for a report configuration, e.g., CSI-ReporConfig as joint CSI and CSI dwelling time report, e.g., cri-RI-PMI-LI-CQI-DwellingTime. If the network entity configures the UE to report more than one CSIs, the UE may report a common CSI dwelling time for each reported CSI, or the UE may report separate CSI dwelling time for each reported CSI. In some examples, the UE 102 determines or triggers the CSI report, which will be discussed in connection with FIG. 13 and FIG. 14 below.

FIG. 13 is a diagram illustrating an example of the UE-determined CSI report. The network entity 104 may configure an indicator enabling the UE 102 to determine whether to report a CSI based on the CSI dwelling time for a report configuration for the CSI report, e.g., CSI-ReporConfig, by the first control signaling and/or the second control signaling.

Referring to FIG. 13, after the network entity 104 transmit a first CRI-RS instance 1308A, the UE 102 transmits a first CSI report 1312A. In some examples, the first CSI report 1312A includes an indication of the CSI dwelling time 1310.

Then, the network entity 104 transmit a second CRI-RS instance 1308B. If the UE 102 identifies the first reported CSI is still valid at the time when the UE 102 is to report the second CSI or before it sends the third CSI report (e.g., periodic or semi-persistent CSI report), the UE 102 can decide not to report the second CSI. As illustrated in FIG. 13, If the time duration from the first CSI report 1312A to the time when the UE 102 is to report the second CSI is less than the CSI dwelling time 1310, the UE 102 skips sending the second CSI report 1312B. The second CSI report is unnecessary.

Afterwards, the network entity 104 transmit a third CRI-RS instance 1308C. If the UE 102 identifies the first reported CSI is not valid at the time when the UE 102 is to send the third CSI report, the UE 102 sends the third CSI report in the configured slot(s) for the third CSI report. For example, the time duration from the first CSI report 1312A to the time when the UE 102 is to report the third CSI is larger than the CSI dwelling time 1310, the UE 102 sends the third CSI report 1312C.

In some examples, the UE starts or resets a timer after a CSI report. The timer expires after the CSI dwelling time. If the configured or triggered CSI report is before the timer expires or if the next periodic or semi-persistent CSI report instance is before the timer expires, the UE may not report the CSI; otherwise, the UE reports the CSI. Alternatively, if the next periodic or semi-persistent CSI report instance is before the timer expires, the UE may not report the CSI; otherwise, the UE reports the CSI.

The functionality for the CSI dwelling time is to determine whether a CSI report to be sent is necessary or not. Based on the CSI dwelling time, the UE can determine whether the most-recent CSI report is still valid or not. For example, when the UE keeps the same moving speed within a given time, the CSI dwelling time could be constant for every CSI report within this time. In this case, the UE only needs to consider the CSI dwelling time for the most-recent CSI report to determine whether a next CSI report is necessary or not. Therefore, as illustrated in FIG. 13, the UE 102 calculates the CSI dwelling time 1310, based on the CSI dwelling time and the time for the first CSI report 1312A, the UE 102 can determine whether to send the second CSI report 1312B.

When there is a new CSI report, e.g., the third CSI report 1312C, the UE 102 may consider the new CSI report, e.g., the third CSI report 1312C, as the starting point for the CSI dwelling time. For example, as illustrated in FIG. 13, after the third CSI report 1312C, the UE102 restarts the timer to check whether any follow-up CSI report after the third CSI report 1312C is necessary or not.

In some examples, the network entity further configures a threshold for the UE to determine whether to report the CSI. The UE starts or resets a timer after a CSI report. The timer expires after the predicted CSI dwelling time.

In some examples, the threshold is performance similarity, such as a cosine similarity (CS) threshold, a square cosine similarity (SCS) threshold, a target spectrum efficiency (SE) offset threshold, or CQI offset threshold between the measured CSI and the reported CSI. As an example, the threshold is the cosine similarity (CS) threshold, or the square cosine similarity (SCS) threshold between the measured CSI and the reported CSI. If the configured or triggered CSI report is before the timer expires and the CS or SCS between the measured CSI and the reported CSI is above the similarity threshold, the UE does not report the CSI; otherwise, the UE reports the CSI. In one example, the UE calculates the CS and SCS as follows:

$$CS = \frac{1}{{N}_{s}} {\sum }_{i = 1}^{{N}_{S}} {\sum }_{j = 1}^{{N}_{R}} \frac{‖ {\tilde{W}}_{i , j}^{H} {W}_{i , j} ‖}{‖ {\tilde{W}}_{i , j}^{H} ‖ ‖ {W}_{i , j} ‖}$$

$$SCS = \frac{1}{{N}_{s}} {\sum }_{i = 1}^{{N}_{S}} {\sum }_{j = 1}^{{N}_{R}} {( \frac{‖ {\tilde{W}}_{i , j}^{H} {W}_{i , j} ‖}{‖ {\tilde{W}}_{i , j}^{H} ‖ ‖ {W}_{i , j} ‖} )}^{2}$$

where W_{i,j} is the j^{th} column of the measured CSI at the i^{th} subband; \tilde{W}_{i,j} is the j^{th} column of the most recent reported CSI at the i^{th} subband; N_{S} is the number of subbands; N_{R} is the number of layers.

As another example, the threshold is the target spectrum efficiency (SE) offset or CQI offset threshold between the measured CSI and the reported CSI. If the configured or triggered CSI report is before the timer expires and the target SE offset or CQI offset between the measured CSI and reported CSI is below the offset threshold, the UE does not report the CSI; otherwise, the UE reports the CSI. In one example, the UE calculates the target SE for a CSI based on the reported CQI and RI as follows:

$$SE = {N}_{R} {SE}_{CQI}$$

where N_{R} is the number of layers indicated by RI; SE_{CQI} is the SE indicated by CQI based on the Table 5.2.2.1-2, Table 5.2.2.1-3, Table 5.2.2.1-4, and Table 5.2.2.1-5 in 3GPP TS 38.214.

In some examples, when the UE determines not to report the CSI, if there is no other uplink control information (UCI) or data scheduled or configured for transmission in the same channel as the CSI report, e.g., PUCCH or PUSCH, the UE does not transmit the PUCCH or PUSCH.

In some examples, when the UE determines not to report the CSI, if there is other uplink control information (UCI) or data scheduled or configured for transmission in the same channel as the CSI report, e.g., PUCCH or PUSCH, the UE does not transmit the PUCCH or PUSCH. In some other examples when the UE determines not to report the CSI, if there is other uplink control information (UCI) or data scheduled or configured for transmission in the same channel as the CSI report, e.g., PUCCH or PUSCH, the UE transmits the other UCI or data in the PUCCH or PUSCH.

In some examples, the network entity configures or indicates two PUCCH resources for a CSI report by the first or second control signaling: one for the UCI report with CSI, the other for UCI report without CSI. If the UE determines to report the CSI, the UE transmits the CSI and the other UCI in the first PUCCH resource; otherwise, the UE transmits the other UCI only in the second PUCCH resource.

In some other examples, the network entity configures or indicates two DMRS sequences, e.g., scramble identifiers (IDs), for a PUCCH or PUSCH resource for a CSI report by the first or second control signaling. If the UE determines to report the CSI, the UE transmits the CSI, the other UCI and data in the PUCCH or PUSCH resource based on the first DMRS sequence; otherwise, the UE transmits the other UCI and data in the PUCCH or PUSCH resource based on the second DMRS sequence.

In some other examples, the network entity performs blind detections to detect whether the CSI is reported or not in the PUCCH or PUSCH. The network entity tries to decode the PUCCH or PUSCH twice: the first time based on resource de-mapping and channel decoding with CSI report and the second time based on resource de-mapping and channel decoding without CSI report.

FIG. 14 is a diagram illustrating an example of a UE-triggered CSI report 1412B. In this example, the network entity 104 configures an indicator enabling the UE triggered CSI report based on the CSI dwelling time for a report configuration for the CSI report, e.g., CSI-ReporConfig, by the first control signaling and/or the second control signaling. Then when a CSI report condition is met or a CSI report event happens, the UE 102 can trigger the CSI report 1412B.

Compared to the UE-determined CSI report scenario illustrated in FIG. 13, the difference is that in the UE-triggered CSI report scenario, the UE 102 can decide to trigger the CSI report 1412B based on a UE detected CSI report condition or event. The UE 102 may transmit the UE-triggered CSI report 1412B by UCI in PUCCH or PUSCH or by MAC CE.

Referring to FIG. 14, after the network entity 104 transmit a first CRI-RS instance 1408A, the UE 102 transmits a first CSI report 1412A. In some examples, the first CSI report 1412A includes an indication of the CSI dwelling time 1410.

Then, the network entity 104 transmits a second CRI-RS instance 1408B. The UE 102 may determine to trigger the CSI report 1412B.

In some examples, the UE determines to trigger the CSI report 1412B if one or a subset of or all of the events happens:

Event 1: The timer for UE-triggered CSI report expires.

Event 2: The offset between the latest measured CSI and the reported CSI is above a similarity threshold or below an offset threshold, where the threshold may be predefined or configured by the first control signaling by the network entity. In one example, the CS or SCS between the measured CSI and the reported CSI is above the similarity threshold. In another example, the SE offset or CQI offset between the measured CSI and the reported CSI is below the offset threshold.

Event 3: The UE receives a new beam indication signaling, e.g., transmission configuration indication (TCI), for the CSI-RS in the configured CSI report configuration for UE-triggered CSI report.

Event 4: The UE activates the secondary cell with the CSI-RS in the configured CSI report configuration for UE-triggered CSI report.

Event 5: The UE switches to the bandwidth part with the CSI-RS in the configured CSI report configuration for UE-triggered CSI report.

Event 6: The UE adds a primary secondary cell with the CSI-RS in the configured CSI report configuration for UE-triggered CSI report.

In some examples, the network entity 104 may configure a dedicated scheduling request (SR) for the UE to trigger uplink resource for CSI report. The SR may be dedicated for the UE-triggered CSI report. Alternatively, the SR can be the shared with other purpose, e.g., uplink resource request for uplink data transmission or beam failure recovery request.

In some other examples, the UE 102 can trigger the uplink resource by contention based random access (CBRA) procedure. In some examples, the UE can transmit the UE-triggered CSI report as MAC CE in message 3 for 4-step based CBRA procedure or message A for 2-step based CBRA procedure. In some other examples, the UE can transmit the UE-triggered CSI report as UCI in in message 3 for 4-step based CBRA procedure or message A for 2-step based CBRA procedure. The network entity may configure two groups of PRACH occasions or resources by RRC signaling, where the first group corresponds to the case without CSI report and the second group corresponds to the case with CSI report. Then the UE may transmit at least one of the PRACH in the second group for UE-triggered CSI report.

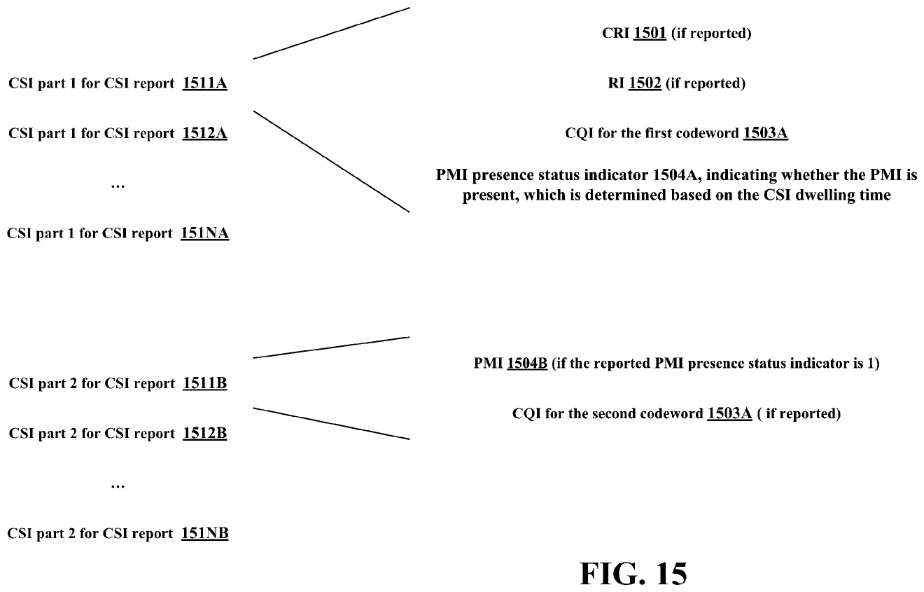

In some examples, the network entity configures the maximum retransmission of the UE-triggered CSI report and/or monitoring window duration for the network response to the UE-triggered CSI report by the first control signaling. After K slots after transmitting the UE-triggered CSI report, where K may be predefined, e.g., K=4, or configured by the network entity via RRC signaling, the UE can start to monitor the response from the network. In some implementations, the network entity may transmit a PDCCH as the response to the UE-triggered CSI report. In some examples, the network response indicates an ACK for the UE-triggered CSI report. If the UE does not receive the network response within the monitoring window and the number of retransmissions of the UE-triggered CSI report is smaller than the configured maximum number of retransmissions of the UE triggered CSI report, the UE retransmits the UE-triggered CSI report; otherwise, the UE resets the timer for the UE-triggered CSI report. In some other examples, the network response indicates a NACK or retransmission for the UE-triggered CSI report. If the UE does not receive the network response within the monitoring window, the UE resets the timer for UE-triggered CSI report; otherwise, the UE may retransmit the UE-triggered CSI report. FIGS. 15-17 illustrate examples of UE reported CSI presence based on the CSI dwelling time.

FIG. 15 is a diagram illustrating an example of the CSI report with a CSI parameter presence status. In some examples, the network entity 104 configures an indicator enabling the UE to determine whether to not report at least one portion of CSI parameters based on the CSI dwelling time for a report configuration for the CSI report, e.g., CSI-ReporConfig, by the first control signaling and/or the second control signaling. Then in the CSI report, the UE 102 may report an indicator indicating whether a portion of the CSI parameters, e.g., PMI, is reported or not, or the UE 102 may report an indicator indicating all CSI parameters are reported or not. Compared to the UE-determined CSI report, the difference is that in this option, the UE 102 always sends a CSI report with an explicit indicator indicating the presence of at least one portion of the CSI parameters.

Referring to FIG. 15, the UE 102 transmits CSI part 1 for CSI reports (e.g., 1511A, 1512A, . . . , 151NA) and CSI part 2 for CSI reports (e.g., 1511B, 1512B, . . . , 151NB). The CSI part 1 for CSI report 1511A includes CRI 1501 (if reported), RI 1502 (if reported), CQI for the first codeword 1503A, and a PMI presence status indicator 1504A indicating whether the PMI is present, which is determined based on the CSI dwelling time. The UE reports the PMI presence status indicator 1504A indicating whether the PMI is present or not for the CSI report. The UE may report an explicit indicator for such indication, e.g., the PMI presence status indicator 1504A. The UE may report the PMI presence status indicator 1504A in the CSI part 1 1511A. In some examples, the UE reports a common presence status indicator for all reported CSI parameters. In some other examples, the UE reports separate presence status indicator(s) for each reported CSI parameter. The UE reports multiple presence status indicators for multiple CSI parameters, each presence status indicator corresponds to one CSI parameter.

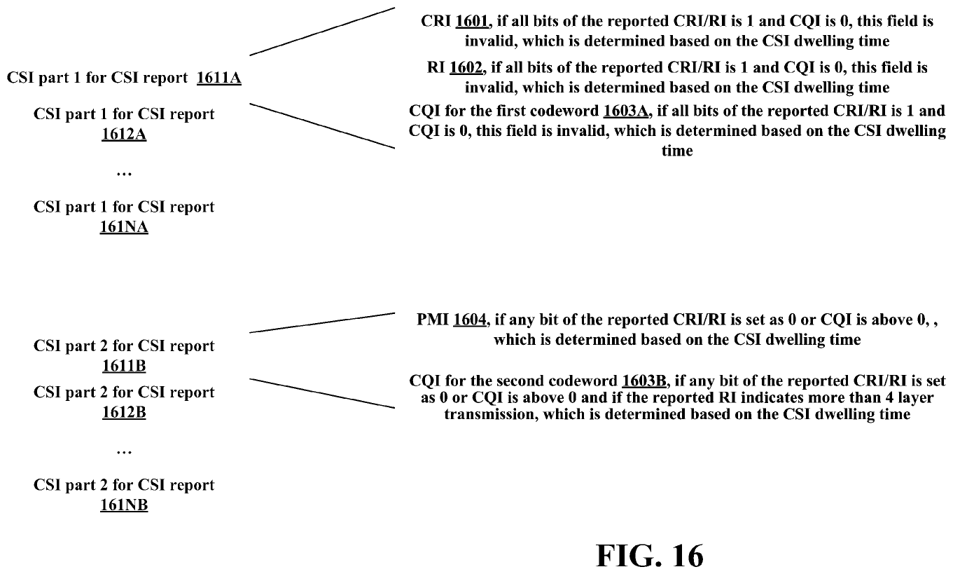

FIG. 16 is a diagram illustrating an example of the CSI report with an implicit indication of the report status for each CSI parameter. The UE determines the report status for each CSI parameter based on the CSI dwelling time. In some examples, the UE reports whether the reported CSI in CSI part 1 and/or part 2 is valid or not. In some examples, the UE reports whether the CSI part 2 is reported by indicating a particular value for CRI/RI/CQI parameter. In some examples, the UE reports whether the reported CSI in CSI part 1 and/or part 2 is valid or not and whether the CSI part 2 is reported by indicating a particular value for CRI/RI/CQI parameter.

Referring to FIG. 16, the UE 102 determines the report status for all CSI parameters based on the CSI dwelling time. In one example, the UE 102 transmits CSI part 1 for CSI reports (e.g., 1611A, 1612A, . . . , 161NA) and CSI part 2 for CSI reports (e.g., 1611B, 1612B, . . . , 161NB). In CSI part 1 for CSI report 1611A, the UE reports a particular value of CRI 1601 or RI 1602, e.g., all bits for the CRI 1601/RI 1602 are set as 1, and/or a particular value of CQI, e.g., CQI for the first codeword 1603A is set to 0, indicating the reported CSI parameters in CSI part 1 for CSI report 1611A and/or CSI part 2 for CSI report 1611B is invalid and/or CSI part 2 1611B is not reported. In the CSI part 2 for CSI report 1611B, the UE reports PMI 1604 if any bit of the reported CRI/RI is set as 0 or CQI is above 0, and the UE reports the CQI for the second codeword 1603B, if any bit of the reported CRI/RI is set as 0 or CQI is above 0 and if the reported RI indicates more than 4 layers transmission.

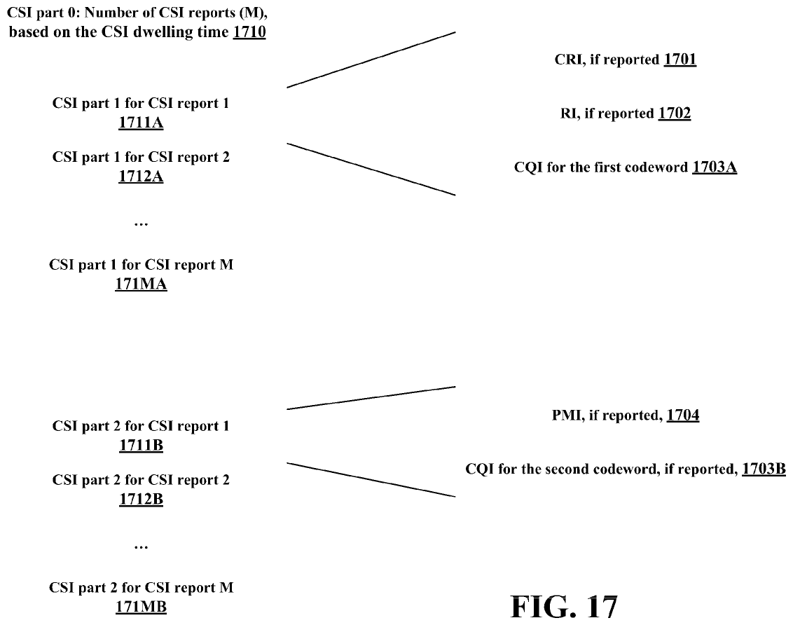

FIG. 17 is a diagram illustrating an example of the CSI report with a number of CSI reports in CSI part 0. In some examples, the UE 102 reports the number of the CSI reports in CSI part 0. In addition to CSI part 1 for CSI reports (e.g., 1711A, 1712A, . . . , 171MA) and CSI part 2 for CSI reports (e.g., 1711B, 1712B, . . . , 171 MB), the UE 102 transmits the CSI part 0 which indicates the number of the CSI reports. The UE may transmit the CSI part 0 in dedicated resource elements and dedicated channel coding, e.g., a polar coding based on the coding rate for the indicated MCS or the PUSCH and a configured coding rate scaling factor. The network entity may configure the UE to report up to a maximum number of N CSI reports, and the UE can indicate the number of reported CSIs by ceil (log₂ N) bits in CSI part 0. Alternatively, in the CSI part 0, the UE may report the presence of each portion of the CSI for each CSI report or all the CSI reports. In one example, the UE may report a 4-bit bitmap indicating the presence of the CRI 1701, RI 1701, CQI for the first codeword 1703A, CQI for the second codeword 1703b, and/or PMI 1704 separately.

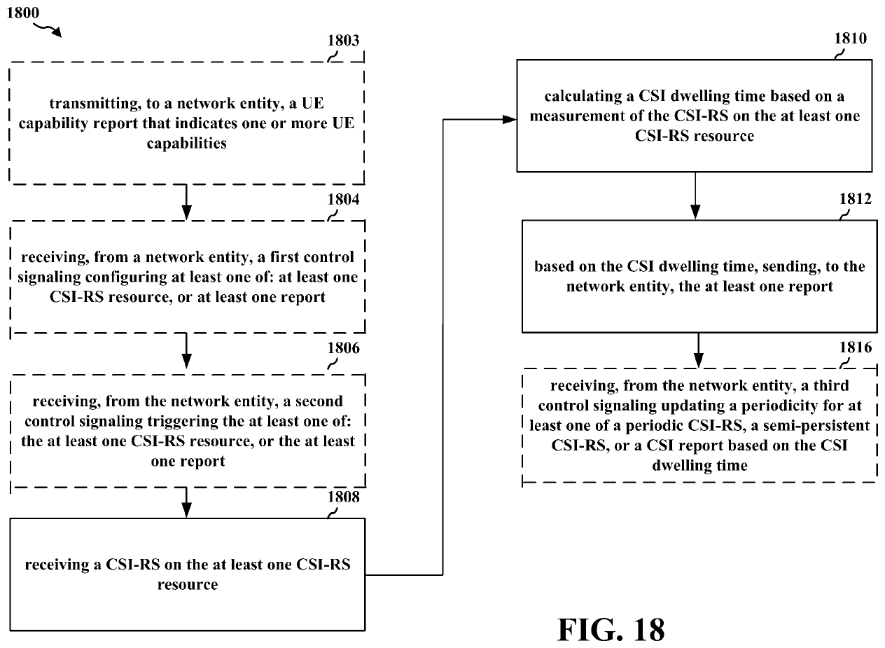

FIG. 18 is a flowchart of a method from a UE-side of a wireless communication link associated with the CSI dwelling time. With reference to FIGS. 1 to 17, the method may be performed by the UE 102, the UE apparatus 1902, etc., which may include the memory 2026′, 2006′, 2016, and which may correspond to the entire UE 102 or the entire UE apparatus 2002, or a component of the UE 102 or the UE apparatus 2002, such as the wireless baseband processor 2026 and/or the application processor 2006.

The UE may transmit 1803, to a network entity, a UE capability report that indicates one or more UE capabilities. For example, referring to FIG. 5, the UE 102 transmits 503 UE capability on CSI dwelling time prediction.

The UE may receive 1804, from the network entity, a first control signaling configuring at least one of: at least one CSI-RS resource, or at least one report. For example, referring to FIG. 5, the UE 102 receives 504 a first control signaling configuring at least one of: a CSI-RS resource for dwelling time prediction, a CSI dwelling time report, or a CSI report. The UE may receive 1806, from the network entity, a second control signaling triggering the at least one of: the at least one CSI-RS resource, or the at least one report. For example, referring to FIG. 5, the UE 102 receives 506 a second control signaling triggering the at least one of: the CSI-RS resource for dwelling time prediction, the CSI dwelling time report, or the CSI report.

The UE receives 1808 a CSI-RS on the at least one CSI-RS resource. For example, referring to FIG. 5, the UE 102 receives 508 at least one CSI-RS on the configured at least one CSI-RS resource

The UE calculates 1810 a CSI dwelling time based on a measurement of the CSI-RS on the at least one CSI-RS resource. For example, referring to FIG. 5 the UE 102 calculates 510 a CSI dwelling time and measure the CSI based on the at least one CSI-RS.

Based on the CSI dwelling time, the UE sends, 1812 to the network entity, the at least one report. For example, referring to FIG. 5, the UE 102 transmits 512 the CSI dwelling time report and/or CSI report. The UE may receive 1814, from the network entity, a third control signaling updating a periodicity for at least one of a periodic CSI-RS, a semi-persistent CSI-RS, or a CSI report based on the CSI dwelling time. For example, referring to FIG. 5, the UE 102 receives 516 the third control signaling updating a periodicity for at least one of a periodic CSI-RS, a semi-persistent CSI-RS, or a CSI report based on the CSI dwelling time. For example, the third control signaling includes a DCI or MAC CE signaling.

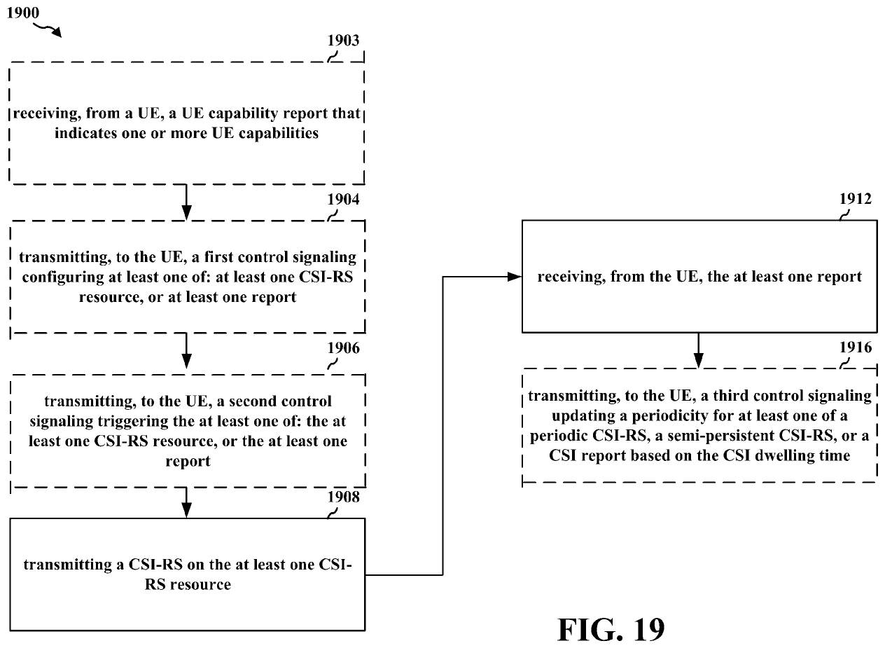

FIG. 19 is a flowchart 1900 of a method from a network-side of the wireless communication link. With reference to FIGS. 1 to 17, the method may be performed by one or more network entities 104, which may correspond to a base station or a unit of the base station, such as the RU 106, the DU 108, the CU 110, an RU processor 2106, a DU processor 2126, a CU processor 2146, etc. The one or more network entities 104 may include memory 2106′/2126′/2146′, which may correspond to an entirety of the one or more network entities 104, or a component of the one or more network entities 104, such as the RU processor 2106, the DU processor 2126, or the CU processor 2146.

The network entity 104 may receive 1903, from a UE, a UE capability report that indicates one or more UE capabilities. For example, referring to FIG. 6, the network entity 104 receives 603 UE capability on CSI dwelling time prediction.

The network entity 104 may transmit 1904, to the UE, a first control signaling configuring at least one of: at least one CSI-RS resource, or at least one report. For example, referring to FIG. 6, the network entity 104 transmits 604 a first control signaling configuring at least one of: a CSI-RS resource for dwelling time prediction, a CSI dwelling time report, or a CSI report. The network entity 104 may transmit 1906, to the UE, a second control signaling triggering the at least one of: the at least one CSI-RS resource, or the at least one report. For example, referring to FIG. 6, the network entity 104 transmits 606 a second control signaling triggering the at least one of: the CSI-RS resource for dwelling time prediction, the CSI dwelling time report, or the CSI report.

The network entity 104 transmits 1908 a CSI-RS on the at least one CSI-RS resource. For example, referring to FIG. 6, the network entity 104 transmits 608 at least one CSI-RS on the configured at least one CSI-RS resource

The network entity 104 receives 1912, the at least one report. For example, referring to FIG. 6, the network entity 104 receives 612 the CSI dwelling time report and/or CSI report. The network entity 104 may transmit 1916, to the UE, a third control signaling updating a periodicity for at least one of a periodic CSI-RS, a semi-persistent CSI-RS, or a CSI report based on the CSI dwelling time. For example, referring to FIG. 6, the network entity 104 transmits 616 a third control signaling updating a periodicity for at least one of a periodic CSI-RS, a semi-persistent CSI-RS, or a CSI report based on the CSI dwelling time. For example, the third control signaling includes a DCI or MAC CE signaling.

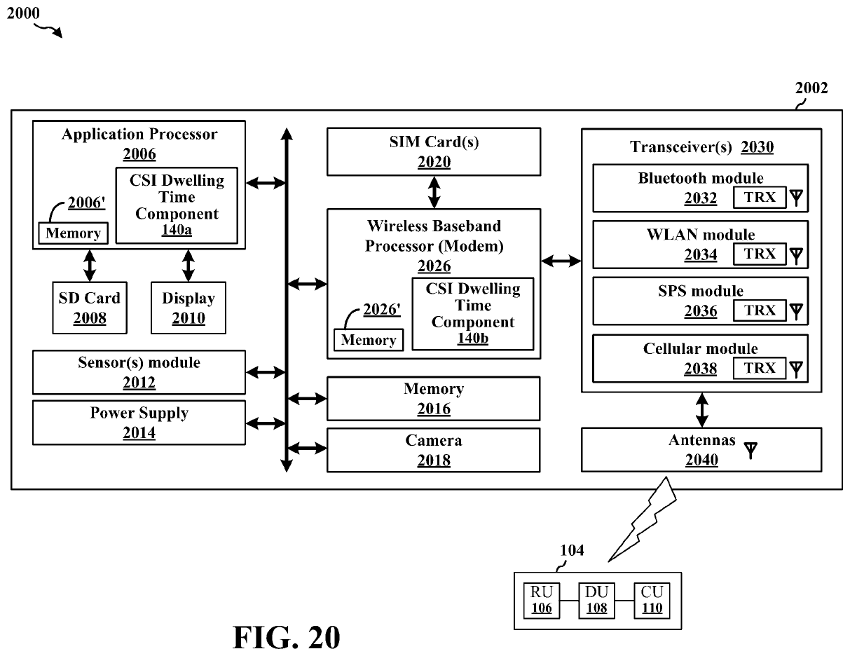

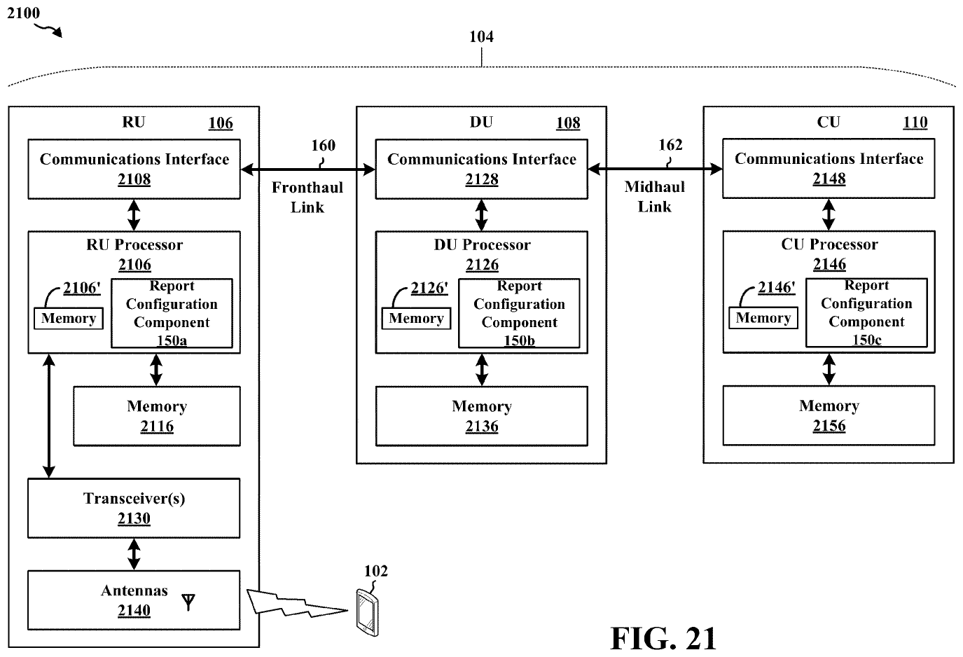

A UE apparatus 2002, as described in FIG. 20, may perform the method of flowchart 1800. The one or more network entities 104, as described in FIG. 21, may perform the method of flowchart 1900.

FIG. 20 is a diagram 2000 illustrating an example of a hardware implementation for a UE apparatus 2002. The UE apparatus 2002 may be the UE 102, a component of the UE 102, or may implement UE functionality. The UE apparatus 2002 may include an application processor 2006, which may have on-chip memory 2006′. In examples, the application processor 2006 may be coupled to a secure digital (SD) card 2008 and/or a display 2010. The application processor 2006 may also be coupled to a sensor(s) module 2012, a power supply 2014, an additional module of memory 2016, a camera 2018, and/or other related components. For example, the sensor(s) module 2012 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 2002 may further include a wireless baseband processor 2026, which may be referred to as a modem. The wireless baseband processor 2026 may have on-chip memory 2026′. Along with, and similar to, the application processor 2006, the wireless baseband processor 2026 may also be coupled to the sensor(s) module 2012, the power supply 2014, the additional module of memory 2016, the camera 2018, and/or other related components. The wireless baseband processor 2026 may be additionally coupled to one or more subscriber identity module (SIM) card(s) 2020 and/or one or more transceivers 2030 (e.g., wireless RF transceivers).

Within the one or more transceivers 2030, the UE apparatus 2002 may include a Bluetooth module 2032, a WLAN module 2034, an SPS module 2036 (e.g., GNSS module), and/or a cellular module 2038. The Bluetooth module 2032, the WLAN module 2034, the SPS module 2036, and the cellular module 2038 may each include an on-chip transceiver (TRX), or in some cases, just a transmitter (TX) or just a receiver (RX). The Bluetooth module 2032, the WLAN module 2034, the SPS module 2036, and the cellular module 2038 may each include dedicated antennas and/or utilize antennas 2040 for communication with one or more other nodes. For example, the UE apparatus 2002 can communicate through the transceiver(s) 2030 via the antennas 2040 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 2026 and the application processor 2006 may each include a computer-readable medium/memory 2026′, 2006′, respectively. The additional module of memory 2016 may also be considered a computer-readable medium/memory. Each computer-readable medium/memory 2026′, 2006′, 2016 may be non-transitory. The wireless baseband processor 2026 and the application processor 2006 may each be responsible for general processing, including execution of software stored on the computer-readable medium/memory 2026′, 2006′, 2016. The software, when executed by the wireless baseband processor 2026/application processor 2006, causes the wireless baseband processor 2026/application processor 2006 to perform the various functions described herein. The computer-readable medium/memory may also be used for storing data that is manipulated by the wireless baseband processor 2026/application processor 2006 when executing the software. The wireless baseband processor 2026/application processor 2006 may be a component of the UE 102. The UE apparatus 2002 may be a processor chip (e.g., modem and/or application) and include just the wireless baseband processor 2026 and/or the application processor 2006. In other examples, the UE apparatus 2002 may be the entire UE 102 and include the additional modules of the apparatus 2002.

As discussed, the CSI dwelling time component 140 is configured to calculate a CSI dwelling time based on a measurement of a CSI-RS on at least one CSI-RS resource. The CSI dwelling time component 140 is further configured to: based on the CSI dwelling time, sending, to a network entity, at least one report. The CSI dwelling time component 140 may be within the application processor 2006 (e.g., at 140a), the wireless baseband processor 2026 (e.g., at 140b), or both the application processor 2006 and the wireless baseband processor 2026. The CSI dwelling time component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

The UE apparatus 2002 may include a variety of components configured for various functions. In examples, the UE apparatus 2002, and in particular the wireless baseband processor 2026 and/or the application processor 2006, includes means for calculating a CSI dwelling time based on a measurement of a CSI-RS on at least one CSI-RS resource; and means for, based on the CSI dwelling time, sending, to a network entity, at least one report. The means may be the CSI dwelling time component 140a-140b of the UE apparatus 2002 configured to perform the functions recited by the means.

FIG. 21 is a diagram 2100 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 2146, which may have on-chip memory 2146′. In some aspects, the CU 110 may further include an additional module of memory 2156 and/or a communications interface 2148, both of which may be coupled to the CU processor 2146. The CU 110 can communicate with the DU 108 through a midhaul link 162, such as an F1 interface between the communications interface 2148 of the CU 110 and a communications interface 2128 of the DU 108.

The DU 108 may include a DU processor 2126, which may have on-chip memory 2126′. In some aspects, the DU 108 may further include an additional module of memory 2136 and/or the communications interface 2128, both of which may be coupled to the DU processor 2126. The DU 108 can communicate with the RU 106 through a fronthaul link 160 between the communications interface 2128 of the DU 108 and a communications interface 2108 of the RU 106.

The RU 106 may include an RU processor 2106, which may have on-chip memory 2106′. In some aspects, the RU 106 may further include an additional module of memory 2116, the communications interface 2108, and one or more transceivers 2130, all of which may be coupled to the RU processor 2106. The RU 106 may further include antennas 2140, which may be coupled to the one or more transceivers 2130, such that the RU 106 can communicate through the one or more transceivers 2130 via the antennas 2140 with the UE 102.

The on-chip memory 2106′, 2126′, 2146′ and the additional modules of memory 2116, 2136, 2156 may each be considered a computer-readable medium/memory.

Each computer-readable medium/memory may be non-transitory. Each of the processors 2106, 2126, 2146 is responsible for general processing, including execution of software stored on the computer-readable medium/memory. The software, when executed by the corresponding processor(s) 2106, 2126, 2146 causes the processor(s) 2106, 2126, 2146 to perform the various functions described herein. The computer-readable medium/memory may also be used for storing data that is manipulated by the processor(s) 2106, 2126, 2146 when executing the software. In examples, the report configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed, the report configuration component 150 is configured to configure at least one report associated with a CSI-RS transmitted on at least one CSI-RS resource. The report configuration component 150 is further configured to receive, from a user equipment (UE), the at least one report associated with the CSI-RS based on a CSI dwelling time.

The report configuration component 150 may be within one or more processors of the one or more network entities 104, such as the RU processor 2106 (e.g., at 150a), the DU processor 2126 (e.g., at 150b), and/or the CU processor 2146 (e.g., at 150c). The report configuration component 150a-150c may be one or more hardware components specifically configured to carry out the stated processes/algorithm, implemented by one or more processors 2106, 2126, 2146 configured to perform the stated processes/algorithm, stored within a computer-readable medium for implementation by the one or more processors 2106, 2126, 2146, or a combination thereof.

The one or more network entities 104 may include a variety of components configured for various functions. In examples, the one or more network entities 104 include means for configuring at least one report associated with a CSI-RS transmitted on at least one CSI-RS resource; and means for receiving, from a user equipment (UE), the at least one report associated with the CSI-RS based on a CSI dwelling time. The means may be the report configuration component 150a-150c of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: calculating a channel state information (CSI) dwelling time based on a measurement of a channel state information reference signal (CSI-RS) on at least one CSI-RS resource; and based on the CSI dwelling time, sending, to a network entity, at least one report.

Example 2 may be combined with example 1 and includes that the calculating the CSI dwelling time includes: measuring a plurality of instances of the CSI-RS on the at least one CSI-RS resource; and computing, using machine learning, the CSI dwelling time according to the measurement of the plurality of instances of the CSI-RS.

Example 3 may be combined with any of examples 1-2 and includes that receiving, from a network entity, a first control signaling configuring at least one of: the at least one CSI-RS resource, or the at least one report; and receiving the CSI-RS on the at least one CSI-RS resource.

Example 4 may be combined with any of examples 1-3 and further includes transmitting, to the network entity, a UE capability report that indicates one or more UE capabilities including: whether the UE supports calculating the CSI dwelling time, a minimum number of measured CSI-RS instances for calculating the CSI dwelling time, or a supported time interval between two consecutive CSI-RS instances for calculating the CSI dwelling time.

Example 5 may be combined with any of examples 1-4 and further includes receiving, from the network entity, a second control signaling triggering the at least one of: the at least one CSI-RS resource, or the at least one report.

Example 6 may be combined with any of examples 1-5 and includes that receiving, from the network entity, a third control signaling updating a periodicity for at least one of: a periodic CSI-RS, a semi-persistent CSI-RS, or a CSI report based on the CSI dwelling time.

Example 7 may be combined with any of examples 1-6 and includes that the at least one report includes a CSI report, the sending, to the network entity, the at least one report includes: transmitting, to the network entity, the CSI report including an indicator based on the CSI dwelling time.

Example 8 may be combined with example 7 and includes that the indicator indicates the CSI dwelling time.

Example 9 may be combined with example 7 and further includes the indicator indicates whether at least one portion of the CSI is not reported.

Example 10 may be combined with any of examples 1-6 and includes that the at least one report includes a CSI dwelling time report, the sending, to the network entity, the at least one report includes: transmitting, to the network entity, the CSI dwelling time report indicating the CSI dwelling time.

Example 11 may be combined with example 10 and includes that the transmitting, to the network entity, the CSI dwelling time report indicating the CSI dwelling time for the CSI-RS includes: transmitting, to the network entity, the CSI dwelling time report indicating the CSI dwelling time for a portion of the configured at least one CSI-RS resource.

Example 12 may be combined with example 10 and further includes the transmitting, to the network entity, the CSI dwelling time report indicating the CSI dwelling time for the CSI-RS includes: transmitting, to the network entity, the CSI dwelling time report indicating the CSI dwelling time for all of the configured at least one CSI-RS resource.

Example 13 may be combined with any of examples 1-12 and includes that the sending the at least one report includes: transmitting the at least one report in response to determining that a most-recent reported CSI is not valid.

Example 14 may be combined with any of examples 1-13 and includes that the UE determines whether the most-recent reported CSI report is valid further based on a performance similarity between the CSI and the most-recent reported CSI.

Example 15 may be combined with any of examples 13-14 and includes that skipping sending, to the network entity, the at least one report in response to determining, based on the CSI dwelling time, that the most-recent reported CSI is valid.

Example 16 is a method of wireless communication at a network entity, including: configuring at least one report associated with a channel state information reference signal (CSI-RS) transmitted on at least one CSI-RS resource; receiving, from a user equipment (UE), the at least one report associated with the CSI-RS based on a CSI dwelling time.

Example 17 may be combined with example 16 and includes that transmitting, to a UE, a first control signaling configuring at least one of: the at least one CSI-RS resource, or the at least one report; and receiving the CSI-RS on the at least one CSI-RS resource.

Example 18 may be combined with any of examples 16-17 and further includes receiving, from the UE, a UE capability report that indicates one or more UE capabilities including: whether the UE supports calculating the CSI dwelling time, a minimum number of measured CSI-RS instances for calculating the CSI dwelling time, or a supported time interval between two consecutive CSI-RS instances for calculating the CSI dwelling time.

Example 19 may be combined with any of examples 16-18 and further includes transmitting, to the UE, a second control signaling triggering the at least one of: the at least one CSI-RS resource, or the at least one report.

Example 20 may be combined with any of examples 16-19 and includes that transmitting, to the UE, a control signaling updating a periodicity for at least one of a periodic CSI-RS, a semi-persistent CSI-RS, or a CSI report based on the CSI dwelling time.

Example 21 may be combined with any of examples 1-20 and further includes the CSI dwelling time represents a predicted validity duration or effective duration for a CSI report.

Example 22 may be combined with example 6 and further includes that the third control signaling includes a DCI or MAC CE signaling.

Example 23 may be combined with example 20 and further includes that the control signaling includes a DCI or MAC CE signaling

Example 24 is an apparatus for wireless communication for implementing a method as in any of examples 1-23.

Example 25 is an apparatus for wireless communication including means for implementing a method as in any of examples 1-23.

Example 26 is a non-transitory computer-readable medium storing computer executable code, the code when executed by at least one processor causes the at least one processor to implement a method as in any of examples 1-23.

1. A method of wireless communication at a user equipment (UE), comprising:
calculating a channel state information (CSI) dwelling time based on a measurement of a channel state information-reference signal (CSI-RS) on at least one CSI-RS resource; and
based on the CSI dwelling time, sending, to a network entity, at least one report when a channel quality indicator (CQI) is set to 0 to indicate that reported CSI is invalid.

2. The method of claim 1, wherein the calculating the CSI dwelling time comprises:
measuring a plurality of instances of the CSI-RS on the at least one CSI-RS resource; and
computing, using machine learning, the CSI dwelling time according to the measurement of the plurality of instances of the CSI-RS.

3. The method of claim 1, further comprising:
receiving, from the network entity, a first control signaling configuring at least one of: the at least one CSI-RS resource, or the at least one report; and
receiving the CSI-RS on the at least one CSI-RS resource.

4. The method of claim 1, further comprising:
transmitting, to the network entity, a UE capability report that indicates one or more UE capabilities including: whether the UE supports calculating the CSI dwelling time, a minimum number of measured CSI-RS instances for calculating the CSI dwelling time, or a supported time interval between two consecutive CSI-RS instances for calculating the CSI dwelling time.

5. The method of claim 1, further comprising:
receiving, from the network entity, a second control signaling triggering the at least one of: the at least one CSI-RS resource, or the at least one report.

6. The method of claim 1, further comprising:
receiving, from the network entity, a third control signaling updating a periodicity for at least one of: a periodic CSI-RS, a semi-persistent CSI-RS, or a CSI report based on the CSI dwelling time.

7. The method of claim 1, wherein the at least one report comprises a CSI report, wherein the sending, to the network entity, the at least one report comprises:
transmitting, to the network entity, the CSI report including an indicator based on the CSI dwelling time.

8. The method of claim 7, wherein the indicator indicates the CSI dwelling time.

9. The method of claim 7, wherein the indicator indicates whether at least one portion of the CSI is not reported.

10. The method of claim 1, wherein the at least one report comprises a CSI dwelling time report, wherein the sending, to the network entity, the at least one report comprises: transmitting, to the network entity, the CSI dwelling time report indicating the CSI dwelling time.

11. The method of claim 10, wherein the transmitting, to the network entity, the CSI dwelling time report indicating the CSI dwelling time for the CSI-RS comprises:
transmitting, to the network entity, the CSI dwelling time report indicating the CSI dwelling time for a portion of the configured at least one CSI-RS resource.

12. The method of claim 10, wherein the transmitting, to the network entity, the CSI dwelling time report indicating the CSI dwelling time for the CSI-RS comprises:
transmitting, to the network entity, the CSI dwelling time report indicating the CSI dwelling time for all of the configured at least one CSI-RS resource.

13. The method of claim 1, wherein the sending the at least one report comprises:
transmitting the at least one report in response to determining that a most-recent reported CSI is not valid.

14. The method of claim 13, further comprising: determining whether the most-recent reported CSI is valid based on a performance similarity between a CSI measured on the CSI-RS and the most-recent reported CSI.

15. The method of claim 13, further comprising;
skip sending, to the network entity, the at least one report in response to determining, based on the CSI dwelling time, that the most-recent reported CSI is valid.

16. A method of wireless communication at a network entity, comprising:
configuring at least one report associated with a channel state information reference signal (CSI-RS) transmitted on at least one CSI-RS resource;
receiving, from a user equipment (UE), the at least one report associated with the CSI-RS based on a CSI dwelling time, when a channel quality indicator (CQI) is set to 0 to indicate that reported CSI is invalid.

17. The method of claim 16, further comprising;
transmitting, to the UE, a control signaling updating a periodicity for at least one of a periodic CSI-RS, a semi-persistent CSI-RS, or a CSI report based on the CSI dwelling time.

18. The method of claim 16, wherein the CSI dwelling time represents a predicted validity duration or effective duration for a CSI report.

19. (canceled)

20. An apparatus for wireless communication comprising:
a transceiver; a memory; and
a processor coupled to the memory and the transceiver, the processor being configured to:
calculate a channel state information (CSI) dwelling time based on a measurement of a channel state information-reference signal (CSI-RS) on at least one CSI-RS resource; and
based on the CSI dwelling time, sending, to a network entity, at least one report when a channel quality indicator (CQI) is set to 0 to indicate that reported CSI is invalid.

21. The apparatus of claim 20, wherein the processor is configured to calculate the CSI dwelling time by:
measuring a plurality of instances of the CSI-RS on the at least one CSI-RS resource; and
computing, using machine learning, the CSI dwelling time according to the measurement of the plurality of instances of the CSI-RS.
